(19) United States
(12) Patent Application Publication
(10) Pub. No.: US 2014/0263719 A1
(43) Pub. Date: Sep. 18, 2014

(54) WATER SPRINKLER SYSTEM

(71) Applicant: Ovie V. Whitson, JR., Shady Shores, TX (US)

(72) Inventor: Ovie V. Whitson, JR., Shady Shores, TX (US)

(21) Appl. No.: 14/217,393

(22) Filed: Mar. 17, 2014

Related U.S. Application Data
(60) Provisional application No. 61/801,735, filed on Mar. 15, 2013.

(51) Int. Cl. A01G 25/16

(52) U.S. Cl. CPC A01G 25/167
USPC 239/63

(57) ABSTRACT

The present invention provides an improved sprinkler system that allows each sprinkler to be independently controlled, thus each sprinkler is its own irrigation zone. Further, the improved sprinkler system operates wirelessly. Each sprinkler includes a valve, a valve control means attached to the valve, a microprocessor connected to the valve control means, and a transceiver connected to the microprocessor. Each sprinkler is in wireless communication with a base station, which can be programmed to individually control each sprinkler Optionally, the sprinkler may include a moisture sensor, which allows for more precise irrigation based on conditions present in or around the sprinkler head. In another embodiment, a valve communicating client (VCC) is connected to a valve control means of a valve. The base station may similarly control the VCC.

### CROSS-REFERENCE TO RELATED APPLICATIONS

This application claims the benefit of U.S. Provisional Application No. 61/801,735, which is hereby incorporated by reference in its entirety.

### TECHNICAL FIELD

The invention relates generally to an improved water sprinkler systems.

### BACKGROUND

In today's water sprinkler systems, water sprinklers are used to irrigate lawns, plants, trees, and other vegetation. Each sprinkler is connected to a water source, typically by a water hose. A valve is used to control the supply of water to the sprinklers. Typically, a single valve will control the water supply to all the sprinklers. In more advanced systems, multiple valves are used to create irrigation zones where each valve controls a set of sprinklers in the zone. In conventional automated systems, the system had a central controller. Each valve was required to be individually wired to the central controller. As such, even systems with only a few zones required complicated and costly wiring. Such wiring increased installation and maintenance costs of such systems. Further, such systems were open loop systems that only operated on a set schedule. Such systems did not account for actual conditions at or around the sprinkler.

As such, an improved sprinkler system is needed.

### SUMMARY

The present invention provides an improved sprinkler system that allows each sprinkler to be independently controlled, thus each sprinkler is its own irrigation zone. Further, the improved sprinkler system operates wirelessly. Each sprinkler includes a valve, a valve control means attached to the valve, a microprocessor connected to the valve control means, and a transceiver connected to the microprocessor. Each sprinkler is in wireless communication with a base station, which can be programmed to individually control each sprinkler Optionally, the sprinklers may include a moisture sensor, which allows for more precise irrigation based on conditions present in or around the sprinkler head. In another embodiment, a valve communicating client (VCC) is connected to a valve control means of a valve. The base station may similarly control the VCC.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of the improved sprinkler system illustrated in a typical residential yard;

FIG. 2 is a block diagram of a sprinkler and a base station used in the improved sprinkler system; and

FIG. 3 is a block diagram of an alternate embodiment of the improved sprinkler system in accordance with the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

Referring to FIG. 1, an improved sprinkler system 100 is illustrated installed in the yard of a residential home. The system 100 comprises one or more sprinklers 200. Five sprinklers 200a, 200b, 200c, 200d, and 200e are shown. However, more or less may be used. Sprinklers 200 are capable of communicating with base station 300 via a wireless connection or over existing wirelines (power-lines). Preferably, base station 300 is installed at a central location, as shown on the side of the residence. Alternatively, the base station may be installed inside a garage or any location that does not prevent or block communication with the sprinklers. Each sprinkler 200 is also connected to a water supply, such as a hose or pipe (not shown), which may be on the surface or buried below the surface. Each sprinkler 200 may be individually controlled, as such each sprinkler provides a separate irrigation zone. Zone A corresponds to sprinkler 200a; Zone B corresponds to sprinkler 200b; Zone C corresponds to sprinkler 200c; Zone D corresponds to sprinkler 200d; and Zone E corresponds to sprinkler 200e.

Referring to FIG. 2, preferred embodiments of sprinkler 200 and base station 300 are provided. Sprinkler 200 comprises a microprocessor 210, memory 220, a transceiver 230, a power supply 240, valve control means 250, and valve 260. Optionally, sprinkler 200 includes moisture sensor 270. This allows the sprinkler to turn off watering when desired moisture levels are reached, thereby conserving water and preventing over watering to an irrigation zone. Moisture sensor 270 may also be used to automatically turn on watering to prevent soil from drying out. Transceiver 230 permits two-way communication with base station 300, which allows it to report moisture conditions and any failures to base station 300. Alternatively, transceiver 230 may be a receiver only, in which case the sprinkler will not be capable of reporting any failures or moisture conditions. Preferably, transceiver 230 uses a 900 MHz radio. Preferably, transceiver 230 may also be powered off to conserve power. Microprocessor 210 may power up the transceiver once a day and make a quick connection to the base station to receive and transmit any necessary data, and then power off the transceiver to conserve power. Power supply 240 may be a battery or preferably an energy harvesting power supply that uses a super cap for storage and the earth as a battery to charge the super cap. As such, no wiring is needed. Valve control means 250 turns on or off valve 260. Valve control means 250 is preferably an electric solenoid or actuator.

Base station 300 comprises microprocessor 310, memory 320, transceiver 330, power supply 340, and user interface 350. Transceiver 330 permits wireless communication with one or more sprinklers 200. The transceiver may send instruction to sprinkler 200 to set watering times and days or the desired moisture levels to be maintained. Power supply 340 may be a battery, an energy harvesting power supply, or other means, including a wired means. User interface 350 provides a means for programming the system. The user interface may be a keypad, touchscreen, wireless interface (e.g., 802.11), Ethernet connection, cellular connection, or a USB connection. Preferably, the user interface is a wireless Internet connection, which allows a user to connect via a PC or smart phone to program the system and also receive update and alerts regarding any failures. The user instructions are stored in memory 320 along with data received from sprinklers 200.

Referring to FIG. 3, an alternate embodiment of a system 400 in accordance with the present invention is provided. System 400 comprises a valve communicating client (VCC) 500 and a base station 600. VCC 500 comprises a microprocessor 510, memory 520, a transceiver 530, and power supply 540. Transceiver 530 permits two-way communication with base station 600, which allows it to report any failures to base station 600. Alternatively, transceiver 530 may be a receiver only, in which case the sprinkler will not be capable of reporting information. Preferably, the transceiver is a powerline transceiver, which permits 2-way communications over a power line. Alternatively, transceiver 530 may be a wireless transceiver, preferably using a 900 MHz radio. Preferably, transceiver 530 may also be powered off to conserve power. Microprocessor 510 may power up the transceiver once a day and make a quick connection to the base station to receive and transmit any necessary data, and then power off the transceiver to conserve power. Power supply 540 is a wired connection in the embodiment with a powerline transceiver. In the wireless embodiment, the power supply 540 may be a battery or a wired connection. VCC 500 is connected to a valve control means 550, which turns on or off valve 560. Valve control means 550 is preferably an electric solenoid. Even though only one VCC 500 is shown, it is contemplated that more than one VCC may be used with a single base station 600, with each VCC controlling a different valve. A single VCC 500 may also be connected to one or more valve control means and thereby control one or more valves independently. Base station 600 is substantially similar to base station 300. Base station 600, via its transceiver 630, may communicate to VCC 500 via its transceiver 530, instructions to cause the valve to be opened or closed, thereby controlling irrigation to the zone. Further, base station 600 may receive information from sprinklers having moisture sensors (not shown) as described above, which may be used to control the valves.

It is understood that the present invention may take many forms and embodiments. Accordingly, several variations may be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A sprinkler comprising:
a wireless receiver configured for receiving a first wireless signal from a base station and generating a second signal in response to receiving the first signal; and
a microprocessor connected to the receiver, the microprocessor being configured to receive the second signal and generate a third signal in response to receiving the second signal;
a valve control means connected to the microprocessor, a valve connected to the valve control means; and
wherein the valve control means is configured to receive the third signal and to open the valve in response to receiving the third signal.

2. The sprinkler of claim 1 further comprising:
a moisture sensor connected to the microprocessor, the moisture sensor being configured for detecting the moisture level approximately in the area of the sprinkler and generating a fourth signal when the moisture sensor detects that the moisture level approximately in the area of the sprinkler is above a predetermined level;
wherein the microprocessor is configured to receive the fourth signal and to generate a fifth signal to the valve control means in response to the fourth signal; and
wherein the valve control means is configured to receive the fight signal and close the valve in response to receiving the fifth signal.

3. The sprinkler of claim 1 further comprising:
a moisture sensor connected to the microprocessor, the moisture sensor being configured for detecting the moisture level approximately in the area of the sprinkler and generating a fourth signal when the moisture sensor detects that the moisture level approximately in the area of the sprinkler is below a predetermined level;
wherein the microprocessor is configured to receive the fourth signal and to generate a fifth signal to the valve control means in response to receiving the fourth signal; and
wherein the valve control means is configured to receive the fifth signal and open the valve in response to receiving the fifth signal.

4. The sprinkler of claim 1 further comprising:
a moisture sensor connected to the microprocessor, the moisture sensor being configured for detecting the moisture level approximately in the area of the sprinkler and generating a fourth signal when the moisture sensor detects that the moisture level approximately in the area of the sprinkler is below a predetermined level;
a transmitter connected to the microprocessor;
wherein the microprocessor is configured to receive the fourth signal and to generate a fifth signal to the transmitter in response to receiving the fourth signal; and
wherein the transmitter is configured to transmit a sixth signal to a base station in response to receiving the fifth signal.

5. The sprinkler of claim 1 further comprising:
a moisture sensor connected to the microprocessor, the moisture sensor being configured for detecting the moisture level approximately in the area of the sprinkler and generating a fourth signal when the moisture sensor detects that the moisture level approximately in the area of the sprinkler is above a predetermined level;
a transmitter connected to the microprocessor;
wherein the microprocessor is configured to receive the fourth signal and to generate a fifth signal to the transmitter in response to receiving the fourth signal; and
wherein the transmitter is configured to transmit a sixth signal to a base station in response to receiving the fifth signal.

6. The sprinkler of claim 1 further comprising an energy harvesting power supply coupled to the microprocessor, the transceiver, and the valve control means.

7. The sprinkler of claim 1 further comprising an energy harvesting power supply coupled to the microprocessor, the transceiver, and the valve control means that is configured to use a super cap for storage and the earth as a battery to charge the super cap.

8. The sprinkler of claim 1 further comprising a battery coupled to the microprocessor, the transceiver, and the valve control means.

9. The sprinkler of claim 1 wherein the wireless receiver comprises a radio configured for receiving and processing approximately 900 MHz signals.

10. A sprinkler system comprising:
a valve having a valve control means for opening and closing the valve;
a valve communicating client connected to the valve control means;
a base station connected to the valve communicating client via a powerline or wireless communications channel, wherein the base station is configured to generate a first signal to the valve communicating client over the channel;
wherein the valve communicating client is configured to receive the first signal and generate a second signal to the valve control means in response to receiving the first signal; and
wherein the valve control means causes the valve to open in response to the second signal.

11. The sprinkler system of claim 10 further comprising:
a sprinkler configured to detect when the moisture level approximately in the area of the sprinkler is above a predetermined level and to transmit a third signal to the base station in response to detecting that the moisture level approximately in the area of the sprinkler is above the predetermined level;
wherein the base station is configured to receive the third signal from the sprinkler and to generate a fourth signal to the valve communicating client over the channel in response to receiving the third signal;
wherein the valve communicating client is configured to receive the fourth signal and generate a fifth signal to the valve control means in response to receiving the fourth signal; and
wherein the valve control means causes the valve to close in response to receiving the fifth signal.

12. The sprinkler system of claim 10 further comprising:
a sprinkler configured to detect when the moisture level approximately in the area of the sprinkler is below a predetermined level and to transmit a third signal to the base station in response to detecting that the moisture level approximately in the area of the sprinkler is below the predetermined level;
wherein the base station is configured to receive the third signal from the sprinkler and to generate a fourth signal to the valve communicating client over the channel in response to receiving the third signal;
wherein the valve communicating client is configured to receive the fourth signal and generate a fifth signal to the valve control means in response to receiving the fourth signal; and
wherein the valve control means causes the valve to open in response to receiving the fifth signal.

13. A base station for use in a sprinkler system, the base station comprising:
a wireless receiver configured to receive a first signal that indicates that the moisture level in an irrigation zone is above a predetermined level and to generate a second signal; and
a microprocessor connected to the receiver;
a wireless or powerline transmitter connected to the microprocessor;
wherein the microprocessor is configured to receive the second signal and to generate a third signal in response to receiving the second signal to the transmitter; and
wherein the transmitter is configured to transmits a fourth signal that causes a valve connected to a sprinkler in the irrigation zone to close.
